(19) United States
(12) Patent Application Publication
(10) Pub. No.: US 2013/0124677 A1
(43) Pub. Date: May 16, 2013

(54) BROADCAST SUPPLEMENTAL DATA TRANSMISSION DEVICE AND BROADCAST SUPPLEMENTAL DATA TRANSMISSION METHOD, AND BROADCAST SYSTEM

(71) Applicants: Hosei Matsuoka, Chiyoda-ku (JP); Akira Yamada, Chiyoda-ku (JP); Tomoyuki Ohya, Chiyoda-ku (JP); Norihiko Nakazawa, Chiyoda-ku (JP); Masayuki Baba, Chiyoda-ku (JP)

(72) Inventors: Hosei Matsuoka, Chiyoda-ku (JP); Akira Yamada, Chiyoda-ku (JP); Tomoyuki Ohya, Chiyoda-ku (JP); Norihiko Nakazawa, Chiyoda-ku (JP); Masayuki Baba, Chiyoda-ku (JP)

(73) Assignees: MITSUBISHI ELECTRIC CORPORATION, Chiyoda-ku (JP); NTT DOCOMO, INC., Chiyoda-ku (JP)

(21) Appl. No.: 13/699,403

(22) PCT Filed: May 20, 2011
(86) PCT No.: PCT/JP11/61686

§ 371 Date: Jan. 24, 2013

(30) Foreign Application Priority Data
May 31, 2010 (JP) 2010-124632

(51) Int. Cl. H04L 29/08

(52) U.S. Cl. CPC H04L 67/02
USPC 709/217

(57) ABSTRACT

Provided is a broadcast supplemental data transmission device, a broadcast supplemental data transmission method, and a broadcast system that can reduce the traffic of a communication network as much as possible at the time of supplementing missing data in broadcasted content data. When “GET HTTP/1.1 If Unmodified Since Time Information”, which is a request for retransmission of missing data containing time information, is received from a receiving device, an HTTP response module determines whether there is rebroadcast of contents containing missing data based on the time information contained in the request for retransmission. When it is determined by the HTTP response module that there is rebroadcast, “412 Precondition Failed”, which is one of error notifications, is transmitted as a response to the receiving device, and the transmission of the contents through a communication network is not performed.

### TECHNICAL FIELD

The present invention relates to a broadcast supplemental data transmission device, a broadcast supplemental data transmission method, and a broadcast system that supplement missing data in content data transmitted through a broadcast wave.

### BACKGROUND ART

As a system for integrating broadcast and communication, the development of the ISDB-Tmm standard, which is an expansion of the terrestrial digital broadcasting standard, is under way. At the same time, the file-casting feature that delivers contents for downloading through a broadcast wave is under consideration.

In the case of delivering contents for downloading through a broadcast wave, some contents cannot be used unless the whole data is completely received. For example, data such as software cannot be used if a part of data is missing.

Further, depending on a missing part, there is a possibility that video or audio data cannot be played or its audio-visual quality is lowered significantly.

Therefore, in the case of delivering such contents for downloading through a broadcast wave, a broadcast supplemental system to which a receiving device can request missing data through communication is under consideration.

For example, according to the invention disclosed in Patent Literature 1, a receiving device notifies missing data information for received broadcast data to a data broadcast device over a communication network to request retransmission of missing data via the communication network.

Such a system that integrates broadcast and communication delivers a large part of data to all receiving device through a broadcast wave and concurrently transmits only a missing part to an individual receiving device in a communication network, thereby enabling highly reliable data transmission as well as reducing the effect on the traffic load on the communication network.

### CITATION LIST

### Patent Literature

Patent Literature 1: Japanese Unexamined Patent Publication No. 2006-165915

### SUMMARY OF INVENTION

### Technical Problem

However, as described in Patent Literature 1, in some cases, it is preferred to reject the request for missing data from the receiving device depending on broadcast programming.

For example, in the case of broadcasting the same content data twice, when the receiving device receives data for the first broadcast and then requests missing data before the second broadcast, it is sometimes preferable that a content transmission device to respond to the request for missing data notifies the receiving device that there is the second broadcast and have it wait until the second broadcast. This is because it is more efficient in terms of the traffic load on the communication network to reduce the use of the communication network as much as possible and receive the data through a broadcast wave.

Further, depending on broadcast programming, there is a possibility that it is decided to broadcast the same content data again after the second broadcast ends. In this case also, the traffic load on the communication network can be reduced if a notification for the rebroadcast can be sent in response to the request for missing data from the receiving device and the receiving device can wait to supplement missing data until the rebroadcast.

To solve the above problem, an object of the present invention is to provide a broadcast supplemental data transmission device, a broadcast supplemental data transmission method, and a broadcast system that can reduce the traffic of a communication network as much as possible at the time of supplementing missing data in broadcasted content data.

### Solution to Problem

To solve the above problem, according to the present invention, there is provided a broadcast supplemental data transmission device that supplements missing data in contents through a communication network in response to a request from a receiving device, which includes receiving means for receiving a missing data retransmission request containing time information from the receiving device, determination means for determining whether there is rebroadcast of contents containing the missing data based on the time information contained in the retransmission request when the missing data retransmission request is received by the receiving means, and transmission means for refraining from transmitting the contents through the communication network when it is determined by the determination means that there is rebroadcast, and transmitting the contents through the communication network when it is determined that there is no rebroadcast.

Further, there is provided a broadcast supplemental data transmission method that supplements missing data in contents through a communication network in response to a request from a receiving device, which includes a receiving step of receiving a missing data retransmission request containing time information from the receiving device, a determination step of determining whether there is rebroadcast of contents containing the missing data based on the time information contained in the retransmission request when the missing data retransmission request is received in the receiving step, and a transmission step of refraining from transmitting the contents through the communication network when it is determined in the determination step that there is rebroadcast, and transmitting the contents through the communication network when it is determined that there is no rebroadcast.

According to the invention, when a missing data retransmission request containing time information is received from the receiving device, it is determined whether there is rebroadcast of contents containing the missing data based on the time information contained in the retransmission request. When it is determined that there is rebroadcast, the transmission of the contents through the communication network is not performed and, when it is determined that there is no rebroadcast, the transmission of the contents through the communication network is performed. It is thereby possible to supplement missing data of the content data which is planned to be rebroadcasted after waiting for the rebroadcast without using a communication network, thereby reducing the traffic of the communication network.

Further, in the broadcast supplemental data transmission device according to the present invention, the time information may be time when the contents are received in the receiving device.

Further, in the broadcast supplemental data transmission device according to the present invention, the time information may be time when the missing data retransmission request is transmitted in the receiving device.

Further, in the broadcast supplemental data transmission device according to the present invention, the transmission means may further transmit a signal indicating an error to the receiving device when it is determined by the determination means that there is rebroadcast, and the receiving device may recognize that there is rebroadcast when the signal indicating an error is received.

According to the invention, when it is determined that there is rebroadcast, a signal indicating an error is transmitted to the receiving device, and the receiving device can recognize that there is rebroadcast by receiving the signal indicating an error. This allows the receiving device to efficiently prepare for the rebroadcast.

Further, in the broadcast supplemental data transmission device according to the present invention, the determination means may compare time indicated by the time information contained in the retransmission request with update time of the contents and thereby determine whether there is rebroadcast after the time indicated by the time information.

According to the invention, by comparing the time indicated by the time information contained in the retransmission request with the predetermined rebroadcast time, the presence or absence of rebroadcast after the time indicated by the time information can be determined. It is thereby possible to reliably determine whether there is rebroadcast or not.

Further, in the broadcast supplemental data transmission device according to the present invention, the receiving means may receive a conditional request containing time information in HTTP as the retransmission request.

According to the invention, by receiving a conditional request containing time information in HTTP as the retransmission request, the existing WEB server that responds to an HTTP request can be used for the broadcast supplemental data transmission device. Further, because the existing WEB server with no extension is available, a device can be introduced at low costs, and the broadcast supplemental data transmission device can be easily distributed among a plurality of devices. It is thereby possible to distribute the traffic of a communication network and the request for missing data.

Further, as described below, the present invention can be also implemented as a broadcast system, in addition to the broadcast supplemental data transmission device and the broadcast supplemental data transmission method. The respective implementation of the invention is different in category, and the same advantageous effects as those of the device are obtained.

A broadcast system according to the present invention is a broadcast system including the above-described broadcast supplemental data transmission device, a broadcast device that broadcasts contents, and a receiving device that receives contents from the broadcast device, and the receiving device includes detection means for detecting missing data in the contents received from the broadcast device, and request means for, when missing data is detected by the detection means, transmitting a retransmission request of the contents containing the missing data together with time information indicating time when the contents are received or time when the retransmission is requested to the broadcast supplemental data transmission device.

Further, a broadcast system according to the present invention is a broadcast system including the above-described broadcast supplemental data transmission device, a broadcast device that broadcasts contents, and a receiving device that receives contents from the broadcast device, and the receiving device includes detection means for detecting missing data in the contents received from the broadcast device, request means for, when missing data is detected by the detection means, transmitting a retransmission request of the contents containing the missing data together with time information indicating time when the contents are received or time when the retransmission is requested to the broadcast supplemental data transmission device, acquisition means for acquiring rebroadcast time information of the contents when an error notification is received from the broadcast supplemental data transmission device in response to the request from the request means, and control means for making transition to a state able to receive a broadcast at time indicated by the rebroadcast time information acquired by the acquisition means.

According to the present invention, when an error notification is received from the broadcast supplemental data transmission device, rebroadcast time information of the contents is acquired, and transition is made to a state able to receive a broadcast at time indicated by the acquired rebroadcast time information, thereby reliably receiving the contents to be rebroadcasted.

### Advantageous Effects of Invention

According to the present invention, it is possible to supplement missing data of the content data which is planned to be rebroadcasted after waiting for the rebroadcast without using a communication network, thereby reducing the traffic of the communication network.

### BRIEF DESCRIPTION OF DRAWINGS

FIG. 1 is a system configuration diagram showing a system configuration of a broadcast system 10 in this embodiment.

FIG. 2 is an explanatory diagram showing a broadcast schedule and broadcast supplement timing.

FIG. 3 is an explanatory diagram schematically showing a content data acquisition process in the case of using “IF Unmodified Since {Time}” in the HTTP GET method.

FIG. 4 is a sequence chart of missing data acquisition process in the case of using the HTTP GET method.

### DESCRIPTION OF EMBODIMENTS

An embodiment of the present invention is described hereinafter with reference to the appended drawings. The same elements are denoted by the same reference numerals where possible, and repeated explanation thereof is omitted.

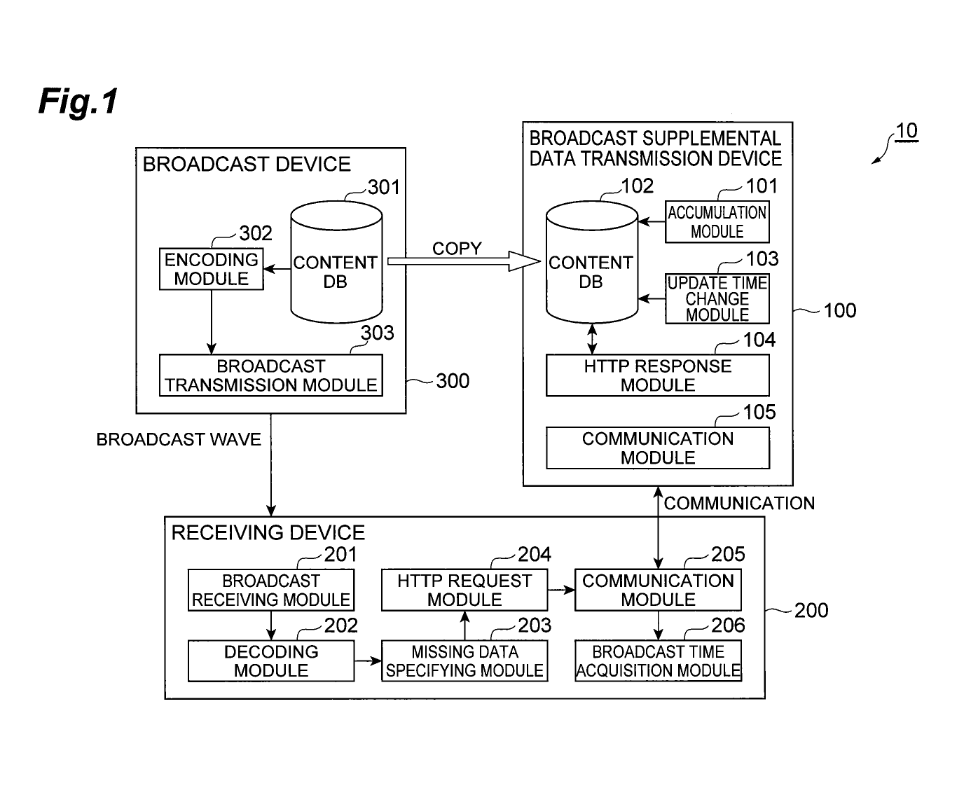

FIG. 1 is a system configuration diagram showing a system configuration of a broadcast system 10 in this embodiment. As shown in FIG. 10, the broadcast system 10 includes a broadcast supplemental data transmission device 100, a receiving device 200, and a broadcast device 300.

The broadcast supplemental data transmission device 100 includes an accumulation module 101, a content DB 102, an update time change module 103, an HTTP response module 104 (receiving means, determination means, and transmitting means), and a communication module 105. The broadcast supplemental data transmission device 100 is a server that stores broadcasted content data and delivers content data in response to a request from the receiving device 200.

The broadcast supplemental data transmission device 100 is composed of a computer system including a CPU, RAM, ROM, communication module and the like, and the CPU operates in accordance with a program stored in the ROM, thereby executing a content data delivery process or the like. The components of the broadcast supplemental data transmission device 100 are described hereinafter.

The accumulation module 101 is a part that stores content data for supplement into the content DB 102. The accumulation module 101 stores content data for supplement into the content DB 102 in accordance with an operation by an operator of the broadcast supplemental data transmission device 100.

The content DB 102 is a database that stores content data for supplement and, in order to extract a data block containing missing data in response to a request from the receiving device 200, the content DB 102 stores the content data in modules of specified blocks in association with an identifier for identifying the block. Further, the content DB 102 stores a broadcast program guide that associates a content data name (or content identifier) with a broadcast time period.

The update time change module 103 is a part that changes the update time of content data. The update time change module 103 performs a changing process in accordance with an operator's operation of the broadcast supplemental data transmission device 100 and can change the update time even when there is no update of content data. Note that the update time indicates the broadcast time of the second broadcast or rebroadcast, and the update time can be changed in conjunction with the broadcast time period of content data in the broadcast program guide.

The HTTP response module 104 is a part that responds to a request for retransmission of missing data that has been received through the communication module 105. To be more specific, the HTTP response module 104 receives a request signal with a conditional request header transmitted from the receiving device 200 and then performs processing in accordance with a case where the condition is satisfied.

For example, the HTTP response module 104 receives a content name of content data (or its identifier) and an identifier of a data block containing missing data, and a broadcast supplement request to which IF Unmodified Since {Broadcast Reception Time} is added as a conditional request header and then checks the broadcast reception time of the content with the update time of the content stored in the content DB and, when the update time is set to be later than the broadcast reception time, determines that the content data is planned to be rebroadcasted. When it is determined that the content data is planned to be rebroadcasted, the HTTP response module 104 sends an error notification to the receiving device 200. When, on the other hand, it is determined that the content data is not planned to be rebroadcasted, the HTTP response module 104 starts transmission of the content data containing missing data.

The communication module 105 is a part that functions as a communication module, and passes a request signal transmitted from the receiving device 200 to the HTTP response module 104 and transmits various signals output from the HTTP response module 104 to the receiving device 200.

The receiving device 200 that receives broadcasted content data from the broadcast device 300 and, when there is missing data in the received content data, makes a request for missing data to the broadcast supplemental data transmission device 100 is described hereinafter. As shown in FIG. 1, the receiving device 200 includes a broadcast receiving module 201 (control means), a decoding module 202, a missing data specifying module 203 (detection means), an HTTP request module 204 (request means), a communication module 205, and a broadcast time acquisition module 206 (acquisition means). The receiving device 200 is a mobile terminal, for example, and is composed of a computer system including a CPU, RAM, ROM, communication module and the like, and the CPU operates in accordance with a program stored in the ROM, thereby executing a content receiving process, a request process or the like. The components of the receiving device 200 are described hereinafter.

The broadcast receiving module 201 is a part that receives broadcasted content data from the broadcasted content data.

The decoding module 202 is a part that decodes the broadcasted content data.

The missing data specifying module 203 is a part that specifies missing data when there is missing data in the received content data. For example, the content data is composed of a plurality of data blocks and, when there is missing data in one of those, a data block containing missing data can be specified by an identifier indicating the data block.

The missing data specifying module 203 may determine whether there is missing data when the content is received by the communication module 205 or may determine whether there is missing data when the content is played or read.

The HTTP request module 204 is a part that transmits a broadcast supplement request for requesting retransmission of the missing data specified by the missing data specifying module 203 to the broadcast supplemental data transmission device 100. The HTTP request module 204 sets time information indicating the time when the content data is received as a condition of the conditional request header and transmits a broadcast supplement request that associates the conditional request header with a content identifier and a block identifier indicating missing data to the broadcast supplemental data transmission device 100 through the communication module 205. Note that, as the time information, the time to transmit the broadcast supplement request may be set instead of the time when the content data is received.

The communication module 205 is a part that executes the function as a communication module, which transmits the broadcast supplement request from the HTTP request module 204 to the broadcast supplemental data transmission device 100 and receives a response from the broadcast supplemental data transmission device 100.

The broadcast time acquisition module 206 is a part that accesses the program guide data reflecting the update time stored in the broadcast supplemental data transmission device 100 and acquires the second broadcast time or rebroadcast time of the content data to which the broadcast supplement request is made when a response signal such as an error is received from the broadcast supplemental data transmission device 100 in response to the broadcast supplement request, which is a request for retransmission of missing data. Upon reaching the acquired second broadcast time or rebroadcast time, the broadcast receiving module 201 becomes ON state so as to receive a broadcast wave of content data from the broadcast device 300 and enters the mode of a kind of reservation for reception.

The broadcast device 300 is described hereinbelow. The broadcast device 300 is a part that broadcasts encoded content data. The broadcast device 300 includes a content DB 301, an encoding module 302, and a broadcast transmission module 303.

The content DB 301 is a part that stores content data to be broadcasted. The content DB 301 stores the content data in association with its broadcast time.

The encoding module 302 is a part that encodes the content data stored in the content DB.

The broadcast transmission module 303 is a part that refers to the broadcast time of the content data stored in the content DB 301 and, upon reaching the broadcast time, causes the encoding module 302 to perform encoding and then broadcasts the encoded content data.

After broadcasting, the broadcast device 300 copies the broadcasted content data into the broadcast supplemental data transmission device 100 according to need. The copying may be performed by an operator of the broadcast supplemental data transmission device 100 or the broadcast device 300, or may be performed automatically via the communication network.

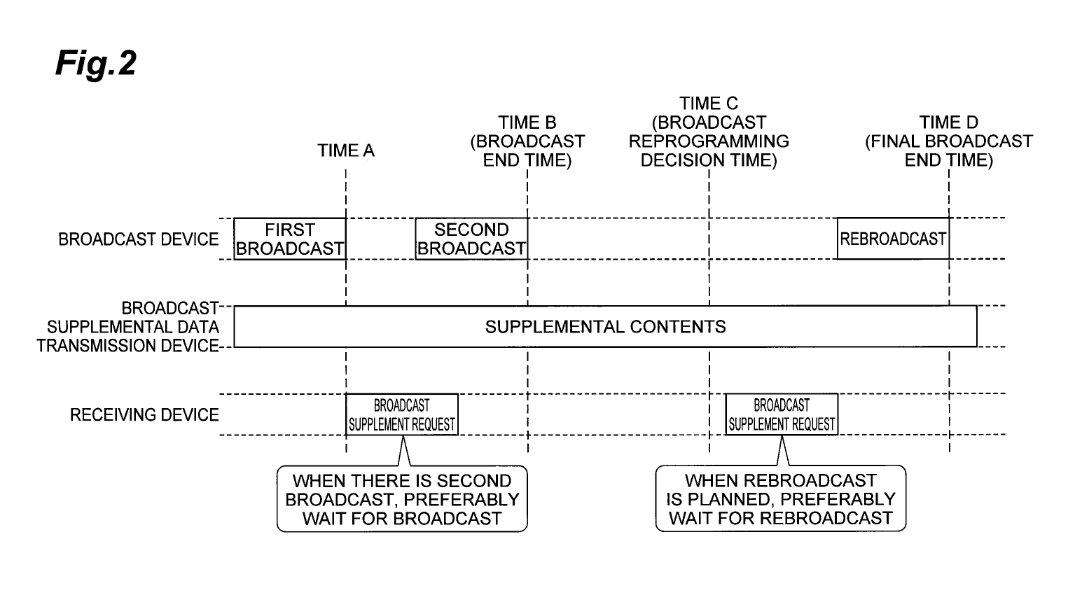

The broadcast schedule and the processing timing of each device in the broadcast system 10 having the above-described configuration are described hereinafter. FIG. 2 is an explanatory diagram showing the broadcast schedule and the broadcast supplement timing.

As shown in FIG. 2, the broadcast device 300 makes the first broadcast of content data and the broadcast ends at time A. When the receiving device 200 that has received the content data detects missing data in the content data at the time receiving or playing the content, it transmits a broadcast supplement request containing a content identifier and an identifier for identifying a data block containing missing data to the broadcast supplemental data transmission device 100.

In the case where the broadcast device 300 makes the second broadcast of the same content data which ends at time B as the broadcast end time, it is more efficient that the receiving device 200 waits until the second broadcast. Therefore, even when the broadcast supplement request is made, the broadcast supplemental data transmission device 100 transmits a response signal such as an error in response to the request to have the receiving device 200 wait to perform a missing data supplement process until the second broadcast.

On the other hand, there is a case where broadcast reprogramming is made by an operator of the broadcast device 300 at the point of time C, which is later than the time B. FIG. 2 shows the case where the rebroadcast is made which ends at time D as the broadcast end time. During the period from the time C to the time D, when the receiving device 200 plays the content, for example, and thereby determines that there is missing data in the content and transmits a broadcast supplement request to the broadcast supplemental data transmission device 100, it is more efficient to wait to acquire the missing data until the rebroadcast. In this case also, the broadcast supplemental data transmission device 100 transmits a response signal such as an error in response to the request to have the receiving device 200 wait until the rebroadcast.

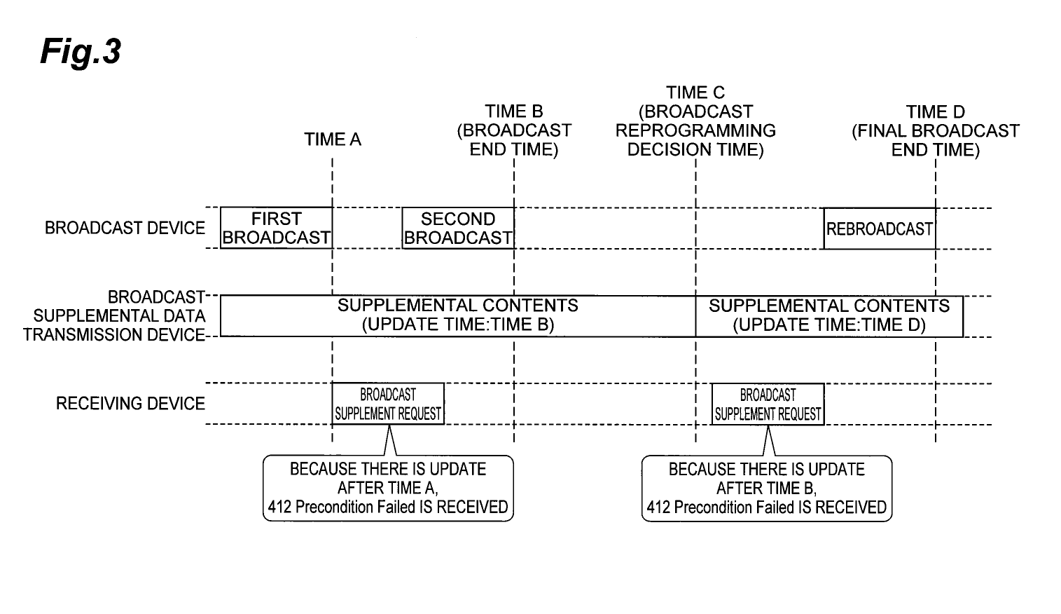

FIG. 3 is an explanatory diagram showing the broadcast schedule and the broadcast supplement timing, which schematically shows a content data acquisition process in the case of using “IF Unmodified Since {Time} ” in the HTTP GET method.

As in the case of FIG. 2, the broadcast device 300 broadcasts the same content data twice, which end at time A and time B, respectively, as the broadcast end time.

When there is missing data in the received content data, the receiving device 200 transmits a signal containing “GET HTTP 1.1 IF Unmodified Since {Time A}” as a broadcast supplement request, which is a request for retransmission, to the broadcast supplemental data transmission device 100. The broadcast supplemental data transmission device 100 stores the time B, which is the second broadcast time, as the update time of the content data, and compares the second broadcast time B with the time A and thereby determines whether or not to retransmit the content data. Although the time A, which is the content data reception end time, is used as the requirements of the condition, this is just an example, and it may be the broadcast start time or the time to transmit a broadcast supplement request (for example, a given point of time between the time A and the time B) as described earlier.

Because the time B is set as the update time after the time A in FIG. 3, the broadcast supplemental data transmission device 100 transmits “412 Precondition Failed”, which is one of error notifications when the condition described in the broadcast supplement request is not satisfied, to the receiving device 200. Receiving the error notification, the receiving device 200 accesses the program guide data stored in the broadcast supplemental data transmission device 100 and acquires the rebroadcast time of the content data containing missing data. Then, the receiving device 200 enters the state able to receive the content data broadcasted at that time.

Further, in the broadcast device 300, broadcast reprogramming is made. In FIG. 3, at the point of time C, the subsequent time D is decided as the rebroadcast time of the content data. Then, in the broadcast supplemental data transmission device 100, the time D is stored as the update time into the content DB 102. In the broadcast supplemental data transmission device 100, the update time is changed even when there is no update of the content data. It is thereby possible to respond to the HTTP conditional request. Note that the update time is a future point of time.

Then, when there is missing data in the content data at the end of the time B, the receiving device 200 transmits the broadcast supplement request again. At this time, a request signal containing “GET HTTP/1.1 IF Unmodified Since {Time B}” is transmitted as the broadcast supplement request to the broadcast supplemental data transmission device 100. Note that, there is a case where it is desirable to view or supplement the content data immediately regardless of the presence or absence of rebroadcast in the receiving device 200. In such a case, the receiving device 200 transmits the broadcast supplement request to the broadcast supplemental data transmission device 100 without adding the conditional request header, so that the content data is supplemented immediately through the communication network.

Because the time D is set as the update time after the time B in FIG. 3, the broadcast supplemental data transmission device 100 transmits “412 Precondition Failed”, which is one of error notifications, to the receiving device 200. Receiving the error notification, the receiving device 200 accesses the program guide data stored in the broadcast supplemental data transmission device 100 and acquires the rebroadcast time of the content data containing missing data. Then, the receiving device 200 enters the state able to receive the content data broadcasted at that time.

In this manner, by setting the rebroadcast time as the update time, it is possible for a device capable of using HTTP to supplement missing data using the rebroadcast without adding any extension to the existing HTTP response server and without using a special protocol.

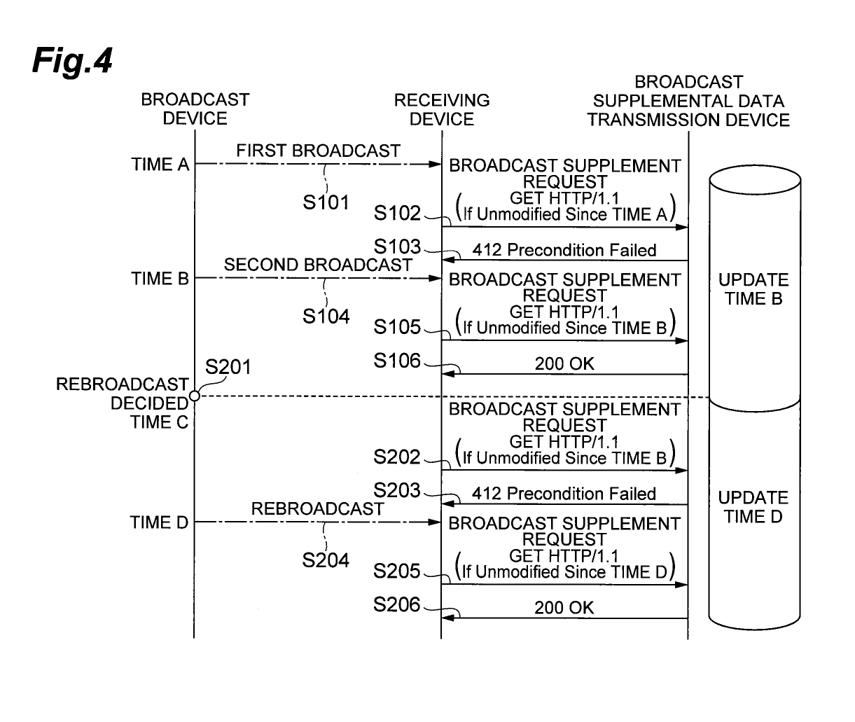

FIG. 4 shows a more detailed sequence chart. In the broadcast device 300, the broadcast transmission module 303 makes the first broadcast of content data which ends at time A as the broadcast end time (S101). In the receiving device 200, the missing data specifying module 203 receives the broadcasted content data and detects missing data in the content data. Then, the HTTP request module 204 transmits “GETHTTP/1.1 If Unmodified Since Time A” as a broadcast supplement request to the broadcast supplemental data transmission device 100. In the broadcast supplemental data transmission device 100, because the rebroadcast time B is stored as the update time, the broadcast supplemental data transmission device 100 transmits “412 Precondition Failed” (S103). The receiving device 200 receives “412 Precondition Failed” and then acquires the rebroadcast time from the broadcast supplemental data transmission device 100 and, upon reaching that time, enters the state able to receive a broadcast wave.

Next, in the broadcast device 300, the broadcast transmission module 303 makes the second broadcast of content data which ends at time B as the broadcast end time (S104). The receiving device 200 receives the content data broadcasted for the second time. The receiving device 200 then detects missing data in the content data and transmits “GET HTTP/1.1 If Unmodified Since Time B” as a broadcast supplement request to the broadcast supplemental data transmission device 100 (S105). Because there is no plan to rebroadcast the content data after the time B, the broadcast supplemental data transmission device 100 transmits “200OK” and retransmits the content data.

After that, at the time C, which is later than the time B, the time D is decided as the rebroadcast time (S201), and the time D is stored as the update time of the content data in the broadcast supplemental data transmission device 100. Then, during the period from the time C to the time D, the receiving device 200 transmits “GET HTTP/1.1 If Unmodified Since Time B” as a broadcast supplement request to the broadcast supplemental data transmission device 100 (S202). Because the time D is set as the update time in the broadcast supplemental data transmission device 100, the broadcast supplemental data transmission device 100 transits “412 Precondition Failed” to the receiving device 200 as a response to the broadcast supplement request (S203). The receiving device 200 receives “412 Precondition Failed” and then acquires the rebroadcast time from the broadcast supplemental data transmission device 100 and, upon reaching that time, enters the state able to receive a broadcast wave. In this case, the receiving device 200 acquires information indicating the time D and enters the state able to receive a broadcast at the time D.

Then, the broadcast device 300 makes the rebroadcast which ends at the time D as the broadcast end time (S204). The receiving device 200 receives the rebroadcasted content data. The receiving device 200 then detects missing data in the content data and transmits “GET HTTP/1.1 If Unmodified Since Time D” as a broadcast supplement request to the broadcast supplemental data transmission device 100 (S205). Because there is no plan to rebroadcast the content data after the time D, the broadcast supplemental data transmission device 100 transmits “200OK” and retransmits the content data (S206).

In this manner, when there is the rebroadcast of content data, missing data can be supplemented by receiving the rebroadcast.

The effects of the broadcast supplemental data transmission device 100 and the broadcast system 10 according to this embodiment are described hereinafter. In the broadcast supplemental data transmission device 100 according to this embodiment, when “GET HTTP/1.1 If Unmodified Since Time Information”, which is a request for retransmission of missing data containing time information, is received from the receiving device 200, the HTTP response module 104 determines whether there is the second broadcast or rebroadcast of contents containing missing data based on the time information contained in the request for retransmission. When it is determined by the HTTP response module 104 that there is the rebroadcast, “412 Precondition Failed”, which is one of error notifications, is transmitted as a response to the receiving device 200, and the transmission of the contents through a communication network is not performed. Note that, in this embodiment, the second broadcast or rebroadcast is referred to as rebroadcast unless otherwise noted.

On the other hand, when it is determined by the HTTP response module 104 that there is no rebroadcast, “200 OK” is transmitted as a response to the receiving device 200, and the transmission of the contents through a communication network is performed. It is thereby possible to supplement missing data of the content data which is planned to be rebroadcasted after waiting for the rebroadcast without using a communication network, thereby reducing the traffic of the communication network.

For example, by comparing the time indicated by the time information contained in “GET HTTP/1.1 If Unmodified Since Time Information” with the predetermined rebroadcast time, the presence or absence of the second broadcast or rebroadcast after the time indicated by the time information can be determined. It is thereby possible to reliably determine whether there is the second broadcast or rebroadcast.

The receiving device 200 may use, as the time information contained in a broadcast supplement request, the time when the content is received or the time when the broadcast supplement request is transmitted in the receiving device 200, or a given point of time between those times. Then, the HTTP response module 104 can compare such time with the rebroadcast time period.

Further, when it is determined that there is the rebroadcast, the broadcast supplemental data transmission device 100 transmits “412 Precondition Failed”, which is a signal indicating an error, to the receiving device 200, and the receiving device 200 can recognize that there is the rebroadcast by receiving “412 Precondition Failed”. This allows the receiving device 200 to efficiently prepare for the rebroadcast.

For example, the receiving device 200 can acquire the rebroadcast time period by accessing the program guide data stored in the broadcast supplemental data transmission device 100 and, by making preparations to receive the content data during that time period, it can reliably receive the content data and supplement the missing data.

As described above, with use of the HTTP conditional request, the existing WEB server that responds to the HTTP request can be used for the broadcast supplemental data transmission device 100. Further, because the existing WEB server with no extension is available, a device can be introduced at low costs, and the broadcast supplemental data transmission device 100 can be easily distributed among a plurality of devices. It is thereby possible to distribute the traffic of a communication network and the request for missing data. Reference Signs List

10 . . . broadcast system, 100 . . . broadcast supplemental data transmission device, 101 . . . accumulation module, 102 . . . content DB, 103 . . . update time change module, 104 . . . HTTP response module, 105 . . . communication module, 200 . . . receiving device, 201 . . . broadcast receiving module, 202 . . . decoding module, 203 . . . missing data specifying module, 204 . . . HTTP request module, 205 . . . communication module, 206 . . . broadcast time acquisition module, 300 . . . broadcast device, 301 . . . content DB, 302 . . . encoding module, 303 . . . broadcast transmission module

1. A broadcast supplemental data transmission device that supplements missing data in contents through a communication network in response to a request from a receiving device, comprising:
receiving means for receiving a missing data retransmission request containing time information from the receiving device;
determination means for determining whether there is rebroadcast of contents containing the missing data based on the time information contained in the retransmission request when the missing data retransmission request is received by the receiving means; and
transmission means for refraining from transmitting the contents through the communication network when it is determined by the determination means that there is rebroadcast, and transmitting the contents through the communication network when it is determined that there is no rebroadcast.

2. The broadcast supplemental data transmission device according to claim 1, wherein
the time information is time when the contents are received in the receiving device.

3. The broadcast supplemental data transmission device according to claim 1, wherein
the time information is time when the missing data retransmission request is transmitted in the receiving device.

4. The broadcast supplemental data transmission device according to claim 1, wherein
the transmission means further transmits a signal indicating an error to the receiving device when it is determined by the determination means that there is rebroadcast, and
the receiving device recognizes that there is rebroadcast when the signal indicating an error is received.

5. The broadcast supplemental data transmission device according to claim 1, wherein
the determination means compares time indicated by the time information contained in the retransmission request with update time of the contents and thereby determines whether there is rebroadcast after the time indicated by the time information.

6. The broadcast supplemental data transmission device according to claim 1, wherein
the receiving means receives a conditional request containing time information in HTTP as the retransmission request.

7. A broadcast system including the broadcast supplemental data transmission device according to claim 1, a broadcast device that broadcasts contents, and a receiving device that receives contents from the broadcast device, the receiving device comprising:
detection means for detecting missing data in the contents received from the broadcast device; and
request means for, when missing data is detected by the detection means, transmitting a retransmission request of the contents containing the missing data together with time information indicating time when the contents are received or time when the retransmission is requested to the broadcast supplemental data transmission device.

8. A broadcast system including the broadcast supplemental data transmission device according to claim 4, a broadcast device that broadcasts contents, and a receiving device that receives contents from the broadcast device, the receiving device comprising:
detection means for detecting missing data in the contents received from the broadcast device;
request means for, when missing data is detected by the detection means, transmitting a retransmission request of the contents containing the missing data together with time information indicating time when the contents are received or time when the retransmission is requested to the broadcast supplemental data transmission device;
acquisition means for acquiring rebroadcast time information of the contents when an error notification is received from the broadcast supplemental data transmission device in response to the request from the request means; and
control means for making transition to a state able to receive a broadcast at time indicated by the rebroadcast time information acquired by the acquisition means.

9. A broadcast supplemental data transmission method that supplements missing data in contents through a communication network in response to a request from a receiving device, comprising:
a receiving step of receiving a missing data retransmission request containing time information from the receiving device;
a determination step of determining whether there is rebroadcast of contents containing the missing data based on the time information contained in the retransmission request when the missing data retransmission request is received in the receiving step; and
a transmission step of refraining from transmitting the contents through the communication network when it is determined in the determination step that there is rebroadcast, and transmitting the contents through the communication network when it is determined that there is no rebroadcast.
